(19) United States
(12) Patent Application Publication
(10) Pub. No.: US 2012/0115468 A1
(43) Pub. Date: May 10, 2012

(54) TECHNIQUE FOR ANCHOR CARRIER SELECTION IN A TELECOMMUNICATION SYSTEM

(75) Inventors: Bengt Lindoff, Bjarred (SE); Muhammad Kazmi, Bromma (SE)

(73) Assignee: TELEFONAKTIEBOLAGET L M ERICSSON (PUBL), Stockholm (SE)

(21) Appl. No.: 13/147,203

(22) PCT Filed: Aug. 12, 2009
(86) PCT No.: PCT/EP2009/005861

§ 371 Date: Oct. 9, 2011

Related U.S. Application Data
(62) Division of application No. 61/149,827, filed on Feb. 4, 2009.

(51) Int. Cl. H04W 24/00; H04W 36/00

(52) U.S. Cl. 455/434

(57) ABSTRACT

The present disclosure relates to a technique for avoiding, forestalling, or reducing re-establishment procedures in a telecommunications system having multiple carriers. A method aspect of this technique includes monitoring a signal quality of an anchor component carrier associated with a serving cell of a mobile terminal and used by the mobile terminal. If the signal quality of the anchor component carrier violates a first signal quality condition, then a parameter (of, e.g., a downlink signal) of at least one candidate component carrier associated with the serving cell and distinct from the anchor component carrier is measured and the signal quality of the at least one candidate component carrier is determined based on the measured parameter. If the determined signal quality fulfils a second signal quality condition, then reselection to the at least one candidate component carrier is initiated such that the candidate component carrier becomes the anchor component carrier associated with the serving cell and used by the mobile terminal.

### TECHNICAL FIELD

The present invention relates to a method and arrangement in a telecommunication system, in particular to a technique for receiving and/or transmitting data on one or more component carriers in an evolved Universal Terrestrial Radio Access Network or similar telecommunication system.

### BACKGROUND

The Long-Term Evolution (LTE) of the Universal Terrestrial Radio Access Network (UTRAN), also denoted E-UTRAN, as standardized in Rel-8 of the 3rd Generation Partnership Project (3GPP) specifications supports transmission bandwidths up to 20 MHz. In order to meet requirements for International Mobile Telecommunications-Advanced (IMT-Advanced), 3GPP has initiated work on LTE-Advanced. One aspect of LTE-Advanced is support for bandwidths larger than 20 MHz.

An important aspect of LTE-Advanced is to allow for backward compatibility with LTE Rel-8. Backward compatibility also includes spectrum compatibility. Thus, to allow for backward compatibility with LTE Rel-8, an LTE-Advanced spectrum or carrier that is wider than 20 MHz appears as a number of separate LTE carriers to an LTE Rel-8 terminal. Separate LTE carriers that constitute an LTE-Advanced carrier may be referred to as component carriers.

To allow for transmission and reception on bandwidths exceeding 20 MHz, LTE-Advanced systems may be operable to transmit and/or receive on multiple component carriers substantially simultaneously. Being operable to transmit and/or receive on multiple component carriers simultaneously to achieve a bandwidth generally greater than 20 MHz may be referred to as component carrier aggregation, or simply carrier aggregation or multi-carrier transmission and reception.

Component carrier aggregation implies that an LTE-Advanced terminal can receive multiple component carriers, where each component carrier may have, or may be modified to have, the same structure as a Rel-8 carrier. A straightforward aggregation of component carriers includes component carrier aggregation of contiguous component carriers.

An example of aggregation of multiple contiguous 20 MHz component carriers is illustrated in FIG. 1. Component carriers 110 in FIG. 1 are all located next to each other so as to be contiguous. Together, the five component carriers 110 shown in FIG. 1 aggregate to an aggregated bandwidth of 100 MHz. The particular component carrier scenario shown in FIG. 1 requires that the operator has access to a contiguous spectrum allocation which can be divided to achieve the number of aggregated component carriers.

To provide additional spectrum flexibility, LTE-Advanced can also support aggregation of non-contiguous component carriers, which may be referred to as spectrum aggregation, an example of which is illustrated in FIG. 2. In the particular example of FIG. 2, five 20 MHz component carriers 210 are spectrum aggregated to provide an aggregated bandwidth of 100 MHz. One or more component carriers 210 are separated by spectrum gaps 220 which separate the one or more component carriers 210 such that those component carriers 210 separated by spectrum gaps 220 are not contiguous.

Spectrum aggregation allows for the flexible addition of dispersed spectrum fragments for transmission. For example, an operator may bring into use different spectrum fragments, which may belong to either the same or different frequency bands, over time depending upon availability for use by the operator.

With respect to the spectrum aggregation scenarios illustrated in FIGS. 1 and 2, it is, of course, also possible to aggregate component carriers having bandwidths smaller than 20 MHz (e.g., to make use of fragmented or non-contiguous junks of spectrum). For instance, operators may choose to combine two non-contiguous 10 MHz component carriers to form 20 MHz aggregated bandwidth.

Through the above-described aggregation techniques, LTE-Advanced systems may thus be operable to transmit and/or receive on multiple component carriers.

In a system utilizing multiple component carriers, it is not optimal, in terms of power consumption (e.g., for a battery operated mobile terminal) to receive control signaling on all or across multiple component carriers. For example, a mobile terminal may be idle or transmitting only voice such that only the capacities of a single component carrier may be required. When a single component carrier provides adequate throughput for data to/from the mobile terminal, transmitting across two or more component carriers will be wasteful, requiring, for example, unnecessary scheduling across component carriers and increased power consumption.

Therefore, the mobile terminal may listen for control signaling on a selected component carrier, and/or transmit and receive control information and data on the selected component carrier. When receiving/transmitting data amounts requiring a larger throughput or greater speed, the mobile terminal may receive data and control signaling on other available component carriers as well as on the selected component carrier. This concept of using a selected component carrier for control signaling may be referred to as anchor carrier use, and the selected component carrier for a mobile terminal may be referred to as the anchor component carrier for this mobile terminal. The anchor component carrier may be selected based on component carrier quality or through network selection.

Thus in both contiguous and non-contiguous carrier aggregation scenarios, a serving cell may utilize an anchor component carrier and one or more further component carriers. Anchor component carrier and further component carriers are sometimes also referred to as primary (component) carrier and secondary or supplementary (component) carriers, respectively.

### SUMMARY

Accordingly, it is an object of the technique disclosed herein to provide for an efficient selection and/or reselection of anchor component carriers. In particular, a technique is needed that allows for the selection and/or reselection of anchor component carriers also across cells and which reduces or minimizes re-establishment procedures, reducing the overall duration thereof.

To this end, according to a first aspect, a method for reselection of an anchor carrier is provided. The method includes monitoring a signal quality of an anchor component carrier associated with a serving cell of a mobile terminal. If the signal quality of the anchor component carrier violates a first signal quality condition, then a parameter of at least one candidate component carrier associated with the serving cell and distinct from the anchor component carrier is measured and the signal quality of the at least one candidate component carrier is determined based on the measured parameter. If the signal quality fulfils a second signal quality condition, then reselection to the at least one candidate component carrier is initiated such that the candidate component carrier becomes the anchor component carrier associated with the serving cell and the mobile terminal. Thus, selection of an anchor component carrier of known signal quality is achieved, allowing for a robust connection between mobile terminal and serving cell. The parameter of the at least candidate component carrier may be measured for a downlink signal of the candidate component carrier, such as a reference signal or any other suitable control channel signal.

According to another aspect, a system operable to implement the above method includes a mobile terminal adapted to perform reselection of an anchor component carrier in conjunction with a network. The mobile terminal may include multiple modules and components for anchor carrier reselection.

The technique proposed herein may be used for or in the process of radio link monitoring including the determination of Out-of-Synchronization (and/or In-Synchronization) of the mobile terminal with the network, the serving cell and/or the anchor component carrier.

A mobile terminal operable to implement the technique proposed herein may have access to a priority list indicative of a plurality of candidate component carriers and of a priority order in which measuring or reselecting is to be performed for the listed candidate component carriers. The priority order of candidate component carriers may be determined based on a respective uplink and/or downlink load of the component carriers, or transmission characteristics of the component carriers. The transmission characteristics of component carriers may include, for example, frequency band, bandwidth, and antenna configuration. The priority order of candidate component carriers may be determined or enforced by a pre-defined rule, a mobile terminal algorithm, or through signaling by the network.

An optional aspect of reselecting a component carrier may include transmitting from the mobile terminal to the serving cell on a specific uplink carrier frequency. The specific uplink carrier frequency may be specified through a rule, a mobile terminal algorithm, or signaling by the network.

According to a further implementation, if the signal quality of the anchor component carrier violates the first signal quality condition, and if the signal quality of all available candidate component carriers fails to fulfil the second signal quality condition, the mobile terminal may be configured to enter a state of Out-of-Synchronization (OoS).

In a further aspect, if the signal quality of available candidate component carriers fails to fulfil the second signal quality condition, radio resource control connection re-establishment may be initiated with a component carrier associated with a neighboring cell. Prior to entering OoS, a data element may be received at the mobile terminal indicating one or more component carriers associated with a neighboring cell. The data element (e.g., an information element) may be indicative of a priority order of the component carriers. If the priority order associated with the neighboring cell is equivalent to a priority order of component carriers of the serving cell, the mobile terminal is configured to attempt RRC connection re-establishment according to the specified priority order. However, if the priority order associated with the neighboring cell is different from a priority order of component carriers of the serving cell, the mobile terminal reads system information or a broadcast channel of the neighboring cell to determine priority of component carriers associated with the neighboring cell.

Thus, if the signal quality of all of the available candidate component carriers in a cell fails to fulfil the second signal quality condition, radio resource control (RRC) connection re-establishment may be initiated with a component carrier of a neighboring cell. Furthermore, the re-establishment may be expedited by the component carrier information contained in the data element (e.g., in the information element) received by the mobile terminal because the mobile terminal may be aware of an optimal or efficient priority order for re-establishing an anchor component carrier. Moreover, because the mobile terminal is notified of component carriers of neighbouring cells through the data element, the mobile terminal may not have to detect component carriers in the neighboring cell or wait for a data element from a base station of the neighboring cell to identify component carriers of the neighboring cell and the associated characteristics, thus expediting re-selection. The signal quality of component carriers of neighboring cells may be determined based on bandwidth, number of base station antennas, signal strength, signal-to-interference ratio (SIR), or block error rate (BLER). Specific examples of signal strength and SIR are reference signal power (RSRP) and reference signal quality (RSRQ), respectively.

The technique disclosed herein provides for an efficient selection and/or re-selection of anchor component carriers. By monitoring the signal quality of the anchor component carrier, and reselecting to a candidate component carrier when the quality of the anchor component carrier drops below a threshold, a good connection between mobile terminal and serving cell may be maintained, reducing connection or re-connection procedures between the mobile terminal and the serving cell caused by poor quality radio links. Furthermore, because in one aspect, the mobile terminal is aware of neighboring cells and the component carriers therein, in the event that a serving cell becomes unsuitable for a mobile terminal, the connection establishment procedures between mobile terminal and a neighboring serving cell may be expedited.

The techniques presented herein may be realized in the form of software, in the form of hardware, or using a combined software/hardware approach. As regards a software aspect, a computer program product comprising program code portions for performing the steps presented herein when the computer program product is run on one or more computing devices may be provided.

The computer program product may be stored on a computer-readable recording medium such as a memory chip, a CD-ROM, a hard disk, and so on. Moreover, the computer program product may be provided for download onto such a recording medium.

### BRIEF DESCRIPTION OF THE DRAWINGS

Further aspects and advantages of the techniques and systems presented herein will become apparent from the following description of embodiments and the accompanying drawings, wherein:

FIG. 1 illustrates an example of carrier aggregation over a contiguous spectrum.

FIG. 2 illustrates an example of carrier aggregation over a non-contiguous spectrum.

FIG. 3 is a diagrammatic representation of an embodiment of a telecommunication system.

FIG. 4 illustrates an example of a spectrum available for use by a telecommunication system.

FIG. 5 is a diagrammatic representation of an embodiment of a mobile terminal.

FIG. 6 shows a flow diagram of a method embodiment for re-selecting an anchor component carrier.

FIG. 7 shows a flow diagram of a method embodiment for re-selecting an anchor component carrier.

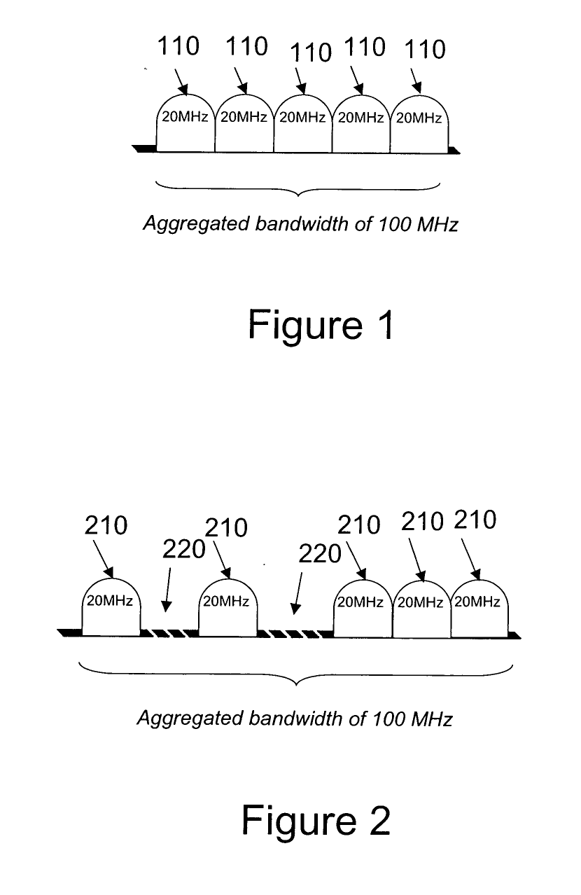

### DETAILED DESCRIPTION

In the following description of preferred embodiments, for purposes of explanation and not limitation, specific details are set forth (such as particular transmitter stage components and sequences of steps) in order to provide a thorough understanding of the present invention. It will be apparent to one skilled in the art that the present invention may be practiced in other embodiments that depart from these specific details. It is evident that the techniques presented herein are not restricted to be implemented in LTE-Advanced systems exemplarily described hereinafter but may also be used in conjunction with other telecommunication systems.

Moreover, those skilled in the art will appreciate that the functions and steps explained herein below may be implemented using software functioning in conjunction with a programmed microprocessor, an Application Specific Integrated Circuit (ASIC), a Digital Signal Processor (DSP) or a general purpose computer. It will also be appreciated that while the following embodiments will primarily be described in context with methods and devices, the invention may also be embodied in a computer program product as well as in a system comprising a computer processor and a memory coupled to the processor, wherein the memory is encoded with one or more programs that may perform the functions and steps disclosed herein.

The following embodiments relate to an LTE-Advanced implementation of an anchor component carrier reselection technique. LTE-Advanced systems are designed to transmit across bandwidths and spectra exceeding 20 MHz. In order to allow for backwards compatibility, the bandwidth or spectrum transmitted upon by an LTE-Advanced system may be separated into frequency resources, or component carriers, which are themselves backwards compatible.

A frequency resource may be thought of as a series of resource blocks having a bandwidth spanning a portion of a spectrum and existing for a span of N consecutive symbols in the time domain. Such time domain symbols may be Orthogonal Frequency Division Multiplexing (OFDM) symbols, and the bandwidth of the resource block may span or include M consecutive subcarriers. Thus a resource block is a block of N×M resource elements. Examples of resource blocks are further discussed in the 3GPP Technical Specification 36.211 V8.7.0 (2009-05). As understood herein, OFDM also comprises Single-Carrier Frequency Division Multiple Access (SC-FDMA), sometimes referred to as Discrete Fourier Transform-spread OFDM.

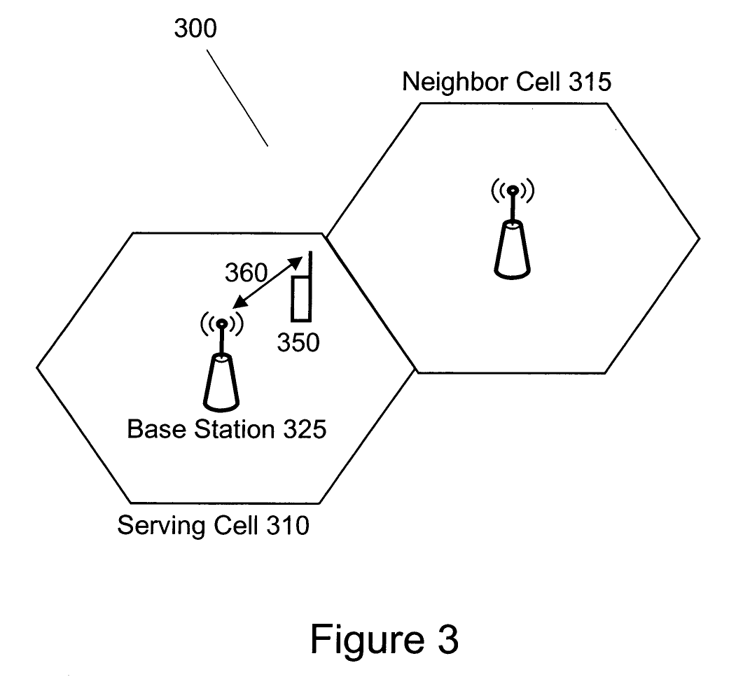

In the embodiments that follow, a frequency resource may be an LTE-Advanced component carrier as utilized by an LTE Rel-8 legacy system. In an implementation example, a component carrier may have a configurable transmission bandwidth up to 20 MHz. FIG. 3 depicts an embodiment of a telecommunication system 300 which is adapted to utilize multiple such component carriers.

Telecommunication system 300 is an LTE-Advanced system and comprises two cells 310 and 315 supporting LTE-Advanced. LTE-Advanced cell 310 is a serving cell having a base station 325 in communication with mobile terminal 350 over connection 360. Serving cell 310 and mobile terminal 350 are operable to communicate with each other over one or more component carriers. Cell 315 is a neighboring cell of serving cell 310.

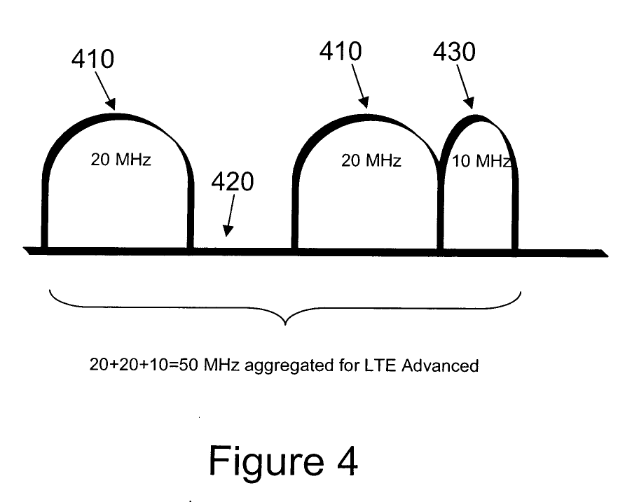

FIG. 4 depicts an example bandwidth spectrum including component carriers which may be used by LTE-Advanced system 300. Serving cell 310 and mobile terminal 350 may transmit and receive control information and data between each other over component carriers 410 and 430. Accordingly, connection 360 between serving cell 310 and mobile terminal 350 may use one or more of component carriers 410 and 430. As shown in FIG. 4, component carriers 410 are separated by gap 420 and have bandwidths of 20 MHZ. Component carrier 430 has a bandwidth of 10 MHz. Thus, LTE-Advanced systems such as LTE-Advanced system 300 have the potential to utilize multiple component carriers, the individual component carriers having the potential for different bandwidths. While the embodiments will be described with regard to component carriers, it is to be understood that the invention is not limited thereto and the invention encompasses the use of all forms of similar frequency resources.

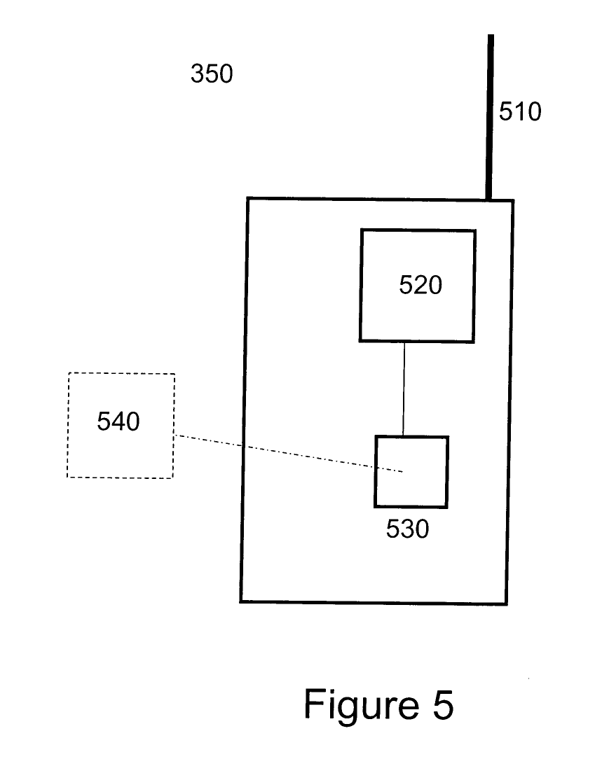

FIG. 5 depicts an embodiment of mobile terminal 350. Mobile terminal 350 includes an antenna 510 for transmitting to or receiving control information and data from base station 325. Antenna 510 may be operable to transmit and receive over component carriers 410 and 430. Although only one antenna 510 is illustrated in FIG. 5, it will be appreciated that mobile terminal 350 could also comprise multiple antennas (e.g., to implement a multiple-input multi-output, or MIMO, scheme).

Mobile terminal 350 further includes a processor 520 coupled to a memory 530. Memory 530 may include one or more programs 540 having computer instructions executable by processor 520. The programs 540 are configured to control the processor 520 to execute the method steps of the techniques discussed herein.

In a system utilizing multiple component carriers as illustrated in FIGS. 3 to 5, it is not optimal for mobile terminal 350 to receive, for example, control signaling on all or across multiple component carriers. For example, mobile terminal 350 may be idle or transmitting voice data such that only the capacities of a single component carrier may be required, e.g., a component carrier 410. When a single component carrier provides adequate throughput for data to/from mobile terminal 350, transmitting across two or more component carriers will be wasteful, requiring, in one example, unnecessary scheduling and increased power consumption. For example, when mobile terminal 350 maintains transmission or reception capability on sub-used or unused component carriers, this may require additional power.

Also, having to receive periodic control information across multiple component carriers 410 and 430 continuously drains the power supply (e.g., the battery) of mobile terminal 350 and may not provide any consequent advantage because the additional bandwidth provided by the additionally maintained component carriers will go unused.

Therefore, mobile terminal 350 may listen for control signaling on a selected component carrier, and/or transmit and receive data on the selected component carrier. When receiving/transmitting data amounts requiring a larger throughput or greater speed, mobile terminal 350 may receive data and control signaling on other available component carriers as well as the selected component carrier.

This concept of using a selected component carrier is referred to as anchor carrier use herein, and the selected component carrier for a mobile terminal is referred to as the anchor component carrier (or simply anchor carrier) for that mobile terminal. The anchor component carrier may be selected based on, for example, component carrier quality or network selection.

In single carrier telecommunication systems, such as LTE Rel-8 systems discussed above, after the dropping of the radio link from the serving cell due to a radio link failure or an Out-of-Synchronization (OoS), which may be the consequence of a radio link failure, the mobile terminal generally attempts to re-establish a connection to the strongest possible serving cell, which may or may not be the previous serving cell to which the mobile terminal was connected before failure or OoS. The process of re-establishing a connection to a serving cell is generally referred to as a Radio Resource Control (RRC) re-establishment procedure. The completion of RRC re-establishment may involve inordinate time. For example, one reason may be because the mobile terminal has to search or synchronize to the new cell and has to read system information or the broadcast channel associated with the new cell before performing the random access procedure for re-establishing the connection with the new cell.

Carrying forward prior art methodology to a system having multiple component carriers results in the implementation of a re-establishment procedure spanning multiple cells when the radio link over the anchor carrier fails or otherwise causes OoS with regard to the anchor component carrier.

In a system having multiple component carriers, in the event that the radio link over an anchor component carrier fails or an OoS otherwise occurs, the mobile terminal may be able to use another component carrier of the serving cell as an anchor carrier, thus avoiding or forestalling the re-establishment procedure which would be required in prior art systems using a single component carrier or other single carrier system. Thus, the availability of one or more of the component carriers can in some scenarios be leveraged to avoid or delay the need for costly RRC re-establishment.

A technique for handling Out-of-Synchronization (OoS) in a multi-carrier system such as, for example, an LTE-Advanced system, is provided hereinafter which has the potential of avoiding or delaying the need for costly RRC re-establishment. In a general aspect of the technique, a mobile terminal is connected to a serving cell on an anchor component carrier and monitors the signal quality of the anchor component carrier. If the signal quality of the anchor component carrier falls below a threshold, the mobile terminal measures the signal quality on other component carriers (e.g., in the serving cell). These other component carriers are also referred to as candidate anchor component carriers herein. If one of the other component carriers is determined to have sufficient signal quality, the mobile terminal selects the component carrier with the sufficient signal quality as the new anchor component carrier, thus avoiding a costly RRC re-establishment caused by radio link failure or OoS.

Further expediting the process of reselecting an anchor carrier, in one aspect, the component carriers available in a serving cell may be known by the mobile terminal prior to anchor component carrier reselection. Information regarding the available component carriers in a serving cell may be received by the mobile terminal at connection set-up or during hand-over of the mobile terminal to the serving cell. In a further aspect, a priority order in which to search and measure component carriers may be based on a priority list of the component carriers available in the serving cell. The priority order of component carriers in the priority list may be, for example, defined by standard, signaled by the network or determined by the mobile terminal.

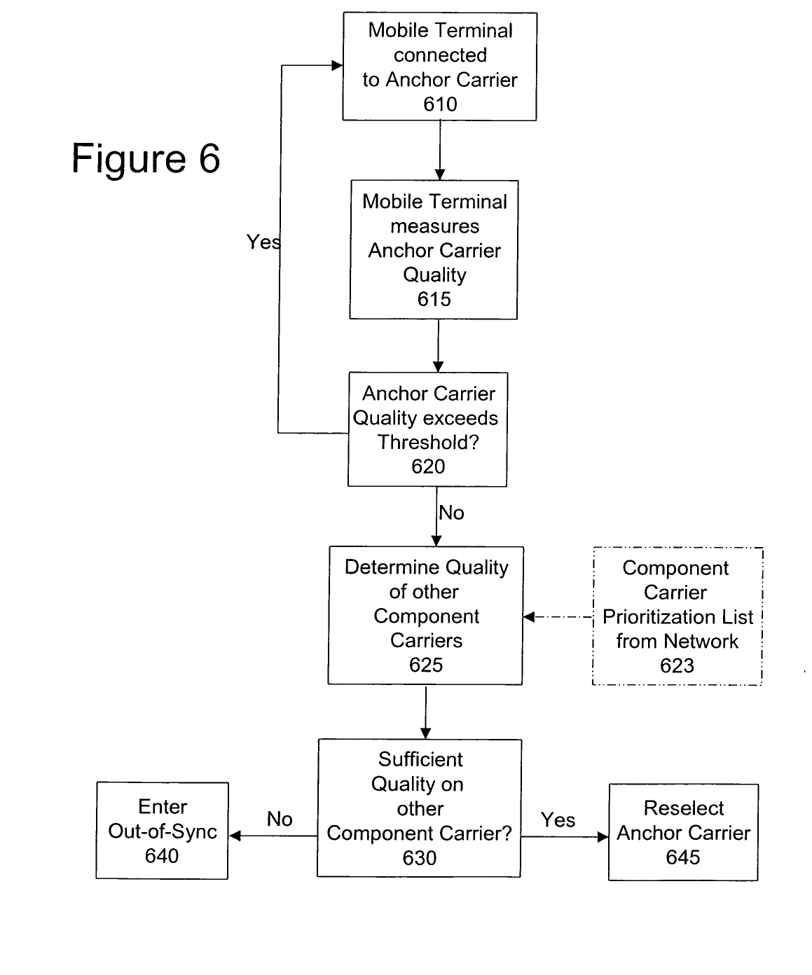

FIG. 6 is a flow diagram of a method embodiment for using one or more candidate anchor component carriers in a multiple carrier system to avoid or delay the need for RRC re-establishment. Initially, as shown at step 610, the mobile terminal (reference numeral 350 in FIG. 3) is connected with a serving cell (reference numeral 310 in FIG. 3) through an anchor component carrier (e.g., component carrier 430 of connection 360 in FIGS. 3 and 4).

At step 615, the mobile terminal measures the anchor component carrier signal quality. In one or more aspects, the anchor component carrier signal quality may be measured based on, for example, a signal strength (e.g., of reference signals or symbols), a Signal-to-Interference Ratio (SIR) of reference signals or symbols, or a Block Error Rate (BLER) of one or more control signals. At step 620, the anchor component carrier signal quality is compared to a threshold, for example, an anchor component carrier quality threshold. If the signal quality of the anchor component carrier exceeds the threshold, the anchor component carrier signal quality is sufficient to maintain a reliable connection to the base station of the serving cell and the mobile terminal remains connected over the anchor component carrier as shown at previous step 610.

According to different aspects, the threshold may be based on one or more parameters of the anchor component carrier. Such parameters include, for example, bandwidth, the number of base station transmit antennas associated with the anchor component carrier or other parameters such as signal strength, SIR or BLER as discussed above.

If at step 620 it is determined that the signal quality of the anchor component carrier falls below the threshold, the mobile terminal proceeds to step 625 and determines the signal quality of other component carriers of the serving cell. Because the signal quality of the anchor carrier falls below the threshold, this indicates that the signal quality of the anchor component carrier is too low for reliable connection to the base station of the serving cell on that particular anchor component carrier. In one aspect, the mobile terminal determines the signal quality of component carriers supported by the base station of the serving cell.

As discussed above, at step 625, the mobile terminal determines the signal quality of other component carriers supported by the serving cell (such as component carriers 420 in FIG. 4). Such component carriers are referred to as candidate (anchor) component carriers. At step 630, the mobile terminal then determines if the signal quality of one or more candidate component carriers supported by the serving cell is sufficient for one of the candidate anchor component carriers to be used as an anchor component carrier. For example, if one or more other candidate component carriers have a signal quality exceeding a threshold, then one of those candidate component carriers with signal quality exceeding the threshold may be used as the anchor component carrier.

The threshold value used to determine if a candidate component carrier has sufficient signal quality to be an anchor component carrier may be the same as or differ from the threshold used to determine the suitability of the anchor component carrier at step 620. For example, the threshold used at step 620 may be based on throughput or bandwidth and the threshold used at step 630 may be based on the number of antennas of a base station associated with the component carriers.

If at step 630 it is determined that the signal quality of one or more candidate component carriers supported by the serving cell is sufficient for a candidate component carrier to be used as an anchor component carrier, then at step 645, the mobile terminal selects a candidate component carrier as the anchor component carrier. For example, at step 645, the mobile terminal may enter a reselection procedure and change the anchor component carrier such that the candidate component carrier becomes the anchor component carrier. If more than one candidate component carriers had sufficient signal quality to serve as the anchor component carrier, then a single candidate component carrier is selected to be the anchor component carrier.

In an example reselection procedure, the mobile terminal contacts the network. In one aspect, if the mobile terminal has, or believes it has, a good timing with the network, the mobile terminal contacts the network by a scheduling request or, if the mobile terminal is out of timing with the network, by using a random access (RACH), for example. The mobile terminal may contact the network on the uplink (UL) carrier frequency associated with the downlink (DL) carrier frequency associated with the lapsed anchor component carrier or on the UL carrier frequency associated with the carrier frequency associated with the reselected anchor component carrier. In different aspects, which UL carrier frequency to use for contacting the network may, for example, be specified in a standard, specified by an algorithm at the mobile terminal, or signaled by the network, for example as part of an Out-of-Synchronization procedure and handling information in a RRC message.

If at step 630 it is determined that the signal quality of candidate component carriers supported by the serving cell is not sufficient for one of the candidate component carriers to be used as an anchor component carrier, then at step 640, the mobile terminal enters a state of Out-of-Synchronization with regard to the serving cell. The mobile terminal may initiate a RRC re-establishment to a detected neighboring cell (such as cell 315 in FIG. 3) or release the connection. If the connection is released, the mobile terminal may attempt to re-establish connection, with, for example, another cell or the serving cell. The steps taken by the mobile terminal subsequent to entering OoS may be defined by a standard or governed by an algorithm in the mobile terminal.

Returning to step 625 of FIG. 6, at step 625, the mobile terminal determines the signal quality of candidate component carriers of the serving cell. The mobile terminal may determine the signal quality of the candidate component carriers in a priority order. In one optional aspect of the present embodiment, the priority order may be based on a priority list received from the network. At step 623, which may be an optional, further aspect, the mobile terminal receives a priority list of component carriers in the serving cell from the network. Then, at step 625, the mobile terminal determines the signal quality of candidate component carriers of the serving cell in a priority order based on the order of candidate component carriers specified in the received priority list. The priority list may be developed according to numerous embodiments and the priority order in which the mobile terminal determines the signal quality of candidate component carriers for anchor component carrier reselection based upon the priority list varies according to different embodiments.

In one exemplary embodiment, the order of component carriers in the priority list is based on DL load or both UL and DL load. For example, the component carrier with largest average DL load, overall or on the control channels of the component carrier, could have the lowest priority in the priority list. The control channel load may be particularly important because loaded control channels may act as a bottleneck for transmitting scheduling allocations or other maintenance related information, for example feedback signaling such as acknowledgments for the mobile terminal. In one aspect of this embodiment, because of varying UL or DL loads, the network may regularly transmit updated priority lists to the mobile terminal.

In another exemplary embodiment, the order of component carriers in the priority list is based on one or more properties of component carriers such as, for example, frequency band, bandwidth or antenna configuration. For example, as discussed with regard to FIG. 4, different component carriers may have different bandwidths and also may also occupy different bands in a spectrum, such as between 2.6 GHz and 900 MHz. Furthermore, different component carriers may, in some serving cells or networks, have different associated antenna configurations. For example, in the serving cell, (M×N)=(4×2) antenna configurations may be used for a few component carriers in order to support legacy systems and (M×N)=(4×4) or (M×N)=(8×4) antenna configurations used for other component carriers to support LTE-Advanced systems. The symbols M and N represent the number of base station transmit antennas and the number of mobile terminal receive antennas, respectively.

Thus, the component carriers may be prioritized in the priority list according to the robustness of the component carriers. For example, the first component carrier in the priority list may be the component carrier with the lowest frequency band, the largest bandwidth or the largest antenna configuration or a combination thereof. The relative robustness of component carriers due to the properties of the individual component carriers may be specified in a standard as a rule, be determined as an algorithm in the mobile terminal, or may be signaled by the network.

In yet another exemplary embodiment, the order of component carriers in the priority list is based on a downlink signal quality of the component carriers. For example, a reference signal/symbol strength, signal/symbol SIR or a BLER of control channels of the downlinks of different component carriers may be measured and used to develop a priority list of the component carriers.

In yet other further embodiments, the order of component carriers in the priority list may be based on any suitable combination of the metrics used in the previously-discussed embodiments for obtaining a priority list. For example, the overall priority may be determined by a function based on a weighted average of priority based on the properties of the different component carriers and priority based the different downlink qualities of the different component carriers. A suitable combination of metrics to be used for obtaining a priority list or a priority order from the priority list may be specified in a standard as a rule, be determined from an algorithm in a mobile terminal, or may be signaled by the network.

In a further aspect, the concept of a priority order of component carriers may be extended to apply to component carriers of one or more neighboring cells (such as cell 315 in FIG. 3). A priority order of component carriers may be used by a mobile terminal for RRC re-establishment in a cell neighboring the serving cell if the mobile terminal enters or may enter OoS with regard to the serving cell. Using a priority order of component carriers when re-establishing RRC in a neighboring cell may allow for faster or more robust re-establishment of the RRC connection with regard to the neighboring cell.

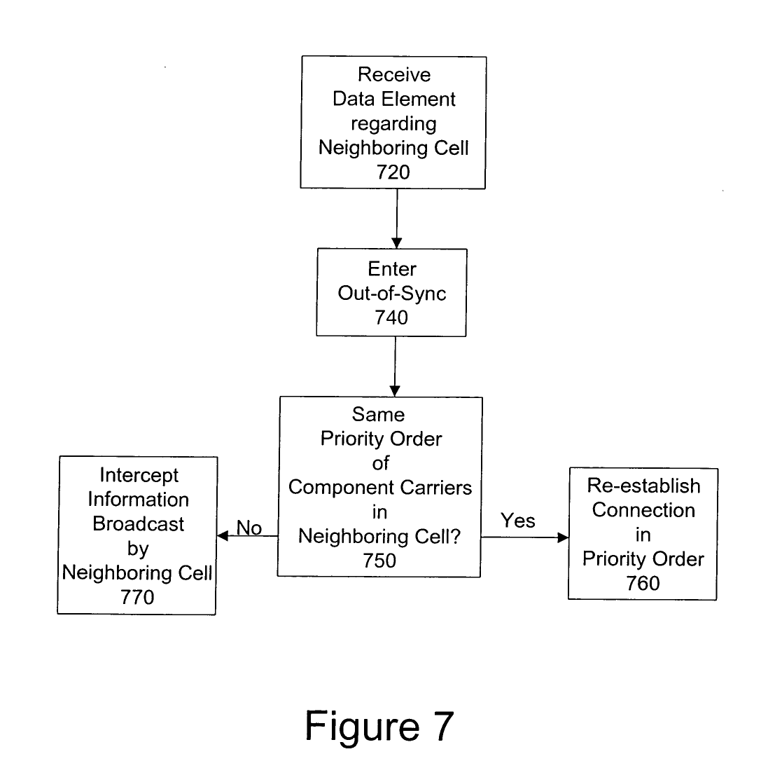

FIG. 7 is a flow diagram of a method embodiment for using a priority order of component carriers for RRC re-establishment with regard to a neighbor cell. In one realization, the method embodiment of FIG. 7 is performed in a mobile terminal (reference numeral 350 in FIG. 3). A serving cell (reference numeral 310 in FIG. 3) may signal or transmit an Information Element (IE) indicating whether component carriers of the neighboring cell(s) have the same priority order as the component carriers of the serving cell. For example, in a specific embodiment, the serving cell can transmit an IE indicating a priority order of candidate component carriers in the specified neighboring cell(s).

At step 720 of FIG. 7, the mobile terminal in the serving cell receives an IE indicating whether the component carriers of a neighboring cell have the same priority order as the component carriers of the serving cell. At step 740, the mobile terminal enters or is about to enter a state of Out-of-Synchronization with regard to the serving cell. At step 750, the mobile terminal determines if the candidate component carriers of the neighboring cell(s) have the same priority as the candidate component carriers of the Out-of-Synchronization (serving) cell based on the received IE.

If it is determined at step 750 that the priority order of candidate component carriers in the neighboring cell is the same as for the component carriers of the Out-of-Synchronization (serving) cell, then at step 760, the mobile terminal attempts to re-establish the RRC connection to the candidate component carriers of the neighboring cell(s) in priority order. This allows for faster and more robust re-establishment of the RRC connection.

If, however, it is determined at step 750 that the priority order of candidate component carriers in the neighboring cell(s) differs from the priority order of the candidate component carriers of the Out-of-Synchronization (serving) cell, then at step 770, the mobile terminal intercepts and reads system information transmitted by the neighboring cell(s) to determine the priority of the candidate component carriers in that cell(s) prior to attempting to re-establish the connection on the component carrier with the highest priority in the neighboring cell(s). Intercepting and reading system information may increase the time to re-establishment of the RRC connection.

The priority of component carriers in the neighboring cell(s) may be based on any suitable combination of the metrics used in the previously-discussed embodiments for obtaining a priority list. For example, the priority may be based on the properties of the different component carriers or the different downlink qualities of the different component carriers. A suitable combination of metrics to be used for obtaining the priority of component carriers for the neighboring cell(s) may be specified in a standard as a rule, be determined as an algorithm in the mobile terminal, or may be signaled by the network.

Either the same or different priority list or criteria for selecting component carriers can be used for OoS handling and for RRC re-establishment. Furthermore, the concept of applying the priority list may be applied for OoS, for RRC re-establishment, or for both.

Referring to mobile terminal 350 of FIG. 5, one or more of the steps performed by a mobile terminal set forth with regard to FIG. 6 and FIG. 7 may be implemented by processor 520 executing computer instructions of programs 540 stored in memory 530.

As has become apparent, the above-disclosed embodiments define a robust OoS procedure for a multi-component carrier system which reduces the risk of dropped calls or quality of service degradation caused by using an anchor component carrier having a substandard signal quality. Furthermore, a robust RRC re-establishment procedure for multi-component carrier systems is defined which allows for faster recovery of RRC connection, for example in a neighboring cell, following radio link failure or OoS.

It is believed that many advantages of the present invention will be fully understood from the forgoing description, and it will be apparent that various changes may be made in the form, construction and arrangement of the exemplary aspects thereof without departing from the scope of the invention or without sacrificing all of its advantages. Because the invention can be varied in many ways, it will be recognized that the invention should be limited only by the scope of the following claims.

1. A method for reselection of an anchor component carrier in a multi-component carrier system, the method comprising:
monitoring a signal quality of an anchor component carrier associated with a serving cell of a mobile terminal and the mobile terminal;
measuring a parameter of at least one candidate component carrier associated with the serving cell and distinct from the anchor component carrier if the signal quality of the anchor component carrier violates a first signal quality condition;
determining a signal quality of the at least one candidate component carrier based on the measured parameter; and
initiating reselecting the at least one candidate component carrier to be the anchor component carrier associated with the serving cell and the mobile terminal if the determined signal quality fulfills a second signal quality condition.

2. The method of claim 1, wherein the said method is for radio link monitoring including the determination of Out-of-Synchronization of the anchor component carrier.

3. The method of claim 1, wherein each component carrier has a spectrum bandwidth spanning a frequency range compatible in bandwidth to a telecommunication system transmission bandwidth.

4. The method of any of claim 1, further comprising providing a priority list indicative of a plurality of candidate component carriers and of a priority order in which at least one of the measuring step and the reselecting step is to be performed for the listed candidate component carriers.

5. The method of claim 4, wherein the priority order of candidate component carriers is determined based on at least one of: a respective uplink and/or downlink load of the component carriers; and transmission characteristics of the component carriers, wherein the transmission characteristics include at least one of frequency band, bandwidth of the component carriers, and antenna configuration.

6. The method of claim 5, wherein the priority order of candidate component carriers is enforced by at least one of: a pre-defined rule, a mobile terminal algorithm, or signalling by the network.

7. The method of claim 1, wherein if the signal quality of the anchor component carrier violates the first signal quality condition, and if the signal quality of all available candidate component carriers fails to fulfill the second signal quality condition, the mobile terminal enters a state of out of synchronization.

8. The method of claim 1, wherein reselecting further comprises transmitting from the mobile terminal to the serving cell on a specific uplink carrier frequency, wherein the uplink carrier frequency is specified through at least one of a rule, a mobile terminal algorithm, and signalling by the network.

9. The method of claim 1, further comprising:
receiving a data element at the mobile terminal indicating one or more component carriers associated with a neighboring cell.

10. The method of claim 9, further comprising:
if the signal quality of the at least one candidate component carrier fails to fulfill the second signal quality condition, initiating radio resource control (RRC) connection re-establishment with a component carrier associated with the neighboring cell.

11. The method of claim 10 in combination with claim 4, wherein the data element is indicative of the priority order of the component carriers, and further comprising, if the priority order associated with the neighboring cell is different from a priority order of component carriers of the serving cell, reading information of the neighboring cell to determine priority of component carriers associated with the neighboring cell.

12. The method of claim 1, wherein signal quality is determined based on at least one of: component carrier bandwidth; number of base station antennas; signal strength; signal-to-interference ratio (SIR); and block error rate (BLER).

13. A mobile terminal operable to reselect an anchor component carrier in a multi-component carrier system, the mobile terminal configured to:
monitor a signal quality of an anchor component carrier connecting the mobile terminal with a serving cell;
measure a parameter of at least one candidate component carrier associated with the serving cell and distinct from the anchor component carrier if the signal quality of the anchor component carrier violates a first signal quality condition;
determine a signal quality of the at least one candidate component carrier based on the measured parameter; and
initiate reselecting the at least one candidate component carrier to be the anchor component carrier connecting the mobile terminal with the serving cell if the determined signal quality fulfills a second signal quality condition.

14. The mobile terminal of claim 13, wherein each component carrier has a spectrum bandwidth spanning a frequency range compatible in bandwidth to a telecommunication system transmission bandwidth.

15. The mobile terminal of claim 13, wherein the mobile terminal has access to a priority list indicative of a plurality of candidate component carriers and of a priority order in which at least one of the measuring step and the reselecting step is to be performed for the listed candidate component carriers.

16. The mobile terminal of claim 15, wherein the priority order of candidate component carriers is determined based on at least one of: an uplink or downlink load of the component carriers; transmission characteristics of the component carriers, wherein the transmission characteristics include at least one of frequency band, bandwidth of the component carriers, and antenna configuration; through a rule; a mobile terminal algorithm; and signalling by the network.

17. The mobile terminal of claim 13, wherein reselecting a component carrier further comprises transmitting from the mobile terminal to the serving cell on a specific uplink carrier frequency, and wherein the uplink carrier frequency is specified through at least one of a rule, a mobile terminal algorithm, and signalling by the network.

18. The mobile terminal of claim 13, wherein the mobile terminal is further configured to:
receive a data element at the mobile terminal indicating one or more component carriers associated with a neighboring cell; and
if the signal quality of the at least one candidate component carrier fails to fulfill the second signal quality condition, initiate radio resource control (RRC) connection re-establishment with a component carrier associated with the neighboring cell.

19. The mobile terminal of claim 18 in combination with claim 15, wherein the data element is indicative of a priority order of the component carriers associated with the neighboring cell, and wherein the mobile terminal is configured to attempt RRC connection re-establishment according to the specified priority order if the neighboring cell component carriers have the same priority order as the component carriers of the serving cell.

20. The method of claim 1, wherein reselecting to the at least one component carrier comprises contacting the associated network by a scheduling request if the mobile terminal determines it has good timing with the network.

21. The mobile terminal of claim 14, wherein the mobile terminal is further configured to contact the associated network by using random access if the mobile terminal is out of contact with the network.
